(19) United States
(12) Patent Application Publication
(10) Pub. No.: US 2025/0180768 A1
(43) Pub. Date: Jun. 5, 2025

(54) LONG OFFSET LOW FREQUENCY SEISMIC SURVEYS USING OPTICAL FIBERS

(71) Applicants: REFLECTION MARINE NORGE AS, Laksevåg (NO); ALCATEL SUBMARINE NETWORKS NORWAY AS, Tiller (NO); NTNU - NORGES TEKNISK - NATURVITENSKAPELIGE UNIVERSITET, Trondheim (NO)

(72) Inventors: Thomas ELBOTH, Oslo (NO); Kambiz IRANPOUR, Oslo (NO); Susann WIENECKE, Trondheim (NO); Svein Arne FRIVIK, Oslo (NO); Jan Kristoffer BRENNE, Trondheim (NO); Martin LANDRØ, Trondheim (NO)

(21) Appl. No.: 18/839,259

(22) PCT Filed: Feb. 17, 2023
(86) PCT No.: PCT/NO2023/050038

§ 371 Date: Aug. 16, 2024

(30) Foreign Application Priority Data
Feb. 18, 2022 (NO) 20220220

(51) Int. Cl. G01V 1/22; G01V 1/38; G01V 8/24

(52) U.S. Cl. CPC G01V 1/226; G01V 1/3808; G01V 8/24; G01V 2210/1427; G01V 2210/167

(57) ABSTRACT

Described herein is a method for performing a long offset refraction seismic survey of a subsurface area of interest using a fiber-optic cable (170) positioned on or under the earth's surface and extending between a first cable end (172) closer to the area of interest and a second cable end further from the area of interest, the method comprising: connecting an interrogator to an end of the fiber-optic cable, wherein the interrogator is configured to emit light into the cable through the end and detect reflected light from the cable; simultaneously steering and activating a low frequency seismic source and operating the interrogator to collect seismic refraction data; wherein steering the source comprises directing the source along a travel path that extends between a first source position closer to the area of interest and a second source position further from the area of interest, wherein the second source position is horizontally offset at least 9 km from the first cable end, and the cable and source travel path extend in opposite directions away from the area of interest, and processing the collected refraction data to build up an image of or extract information about the subsurface area of interest.

The present invention relates to a method for obtaining seismic data using optical fibers as seismic sensors, and in particular to a method for performing a seismic survey of a subsurface area of interest using optical fibers as seismic sensors combined with low frequency sources and long offsets.

Seismic exploration uses one or more seismic energy sources to generate an acoustic signal, which propagates into the earth's subsurface and is partially reflected or refracted by seismic reflectors (i.e., interfaces between subsurface lithologic or fluid layers characterized by different elastic properties). The reflected or refracted signals (known as “seismic data”) are detected and recorded by seismic receivers located at or near the surface of the earth, thereby generating a seismic survey of the subsurface. The recorded signals, or seismic data, can then be processed to recover information relating to the lithologic subsurface formations, identifying such features as, for example, lithologic subsurface formation boundaries. Those skilled in interpreting such data can infer the presence of oil or gas within the subsurface, or can study how an injected CO₂ plume develops and moves/migrates within the subsurface. The seismic data can also be used to derive information about subsurface properties which can be valuable for those carrying out construction work. The data can inform as to where and how to place foundations for windmills, anchoring sites, and pipelines, or can assist in searches for seabed minerals and in inferring the presence of shallow gas, the latter being relevant in terms of risk reduction (QHSE).

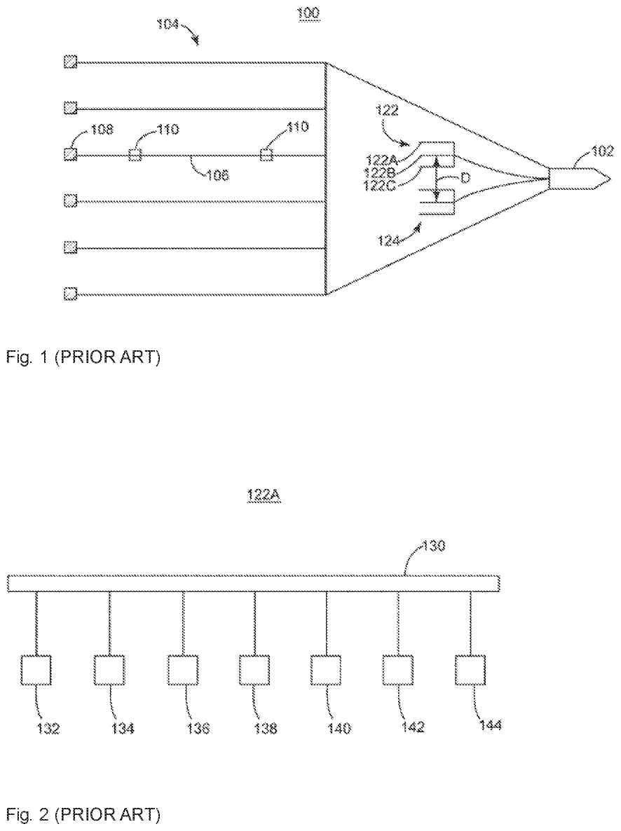

For a conventional seismic gathering process, as illustrated in FIG. 1, a seismic acquisition system 100 includes a vessel 102 towing a seismic spread 104 (i.e., plural streamers 106 and associated equipment, such as float 108). Each streamer 106 can typically be up to 8 km or 9 km long and includes plural seismic sensors 110 for recording seismic data. Only two of these sensors are illustrated in the figure for simplicity. The vessel also tows one or more seismic source arrays (two are illustrated here) 122 and 124, which are configured to generate seismic waves. Each seismic source array can include a plurality of sub-arrays 122A-C, such as three sub-arrays, with each sub-array comprising a given number of seismic source elements. Marine seismic acquisition employing more than two source arrays is now regularly being used because this allows for denser sampling, particularly in the crossline direction.

The most common source type in marine seismic exploration is the air-gun array. This type of array is typically made up of one to three sub-arrays, with each sub-array including a plurality of seismic source elements (air-guns). A seismic source sub-array 122A is illustrated in FIG. 2 comprising a float 130 to which seven seismic source elements 132 to 144 are attached. Of course, the number of sub-arrays used and the number of source elements in each array can be varied depending on need. Instead of using air-guns as the seismic sources marine vibrators can be used or, in a land-based setting, a land vibrator or explosive changes can replace the air-gun sources. NO-A-20201176 describes a system for carrying out a seismic survey wherein distributed acoustic sensing (DAS) streamers are included in a spread to be towed behind a vessel. WO-A-2019/014721 describes a system for distributed acoustic sensing in a marine environment including at least one DAS unit for transmitting light along a section of fiber-optic cable and repeaters to allow the cable to act as a sensor over a longer distance. WO-A-2017/086952 describes a sensing system including sections of fiber-optic cable which are wrapped around a spherical object to increase the fidelity of sensor data in that region of the cable.

As mentioned above, in a marine environment the seismic receivers can be towed behind a vessel in long cables known as streamers, or they can be placed on the seafloor as nodes or seabed cables. The use of nodes or cables located on the seafloor is both costly and represents a time-consuming operation, but is still often preferred since stationary sensors on the seafloor can record high fidelity data and the data collected is subject to lower levels of noise. Receivers have traditionally been made up of hydrophones, but in recent years other sensor types such as geophones, accelerometers, and various forms of MEMS sensors have increasingly been deployed in order to supplement or replace the hydrophone measurements.

In a typical seismic survey, both reflection and refraction data are recorded on the receivers. Reflection waves travel downwards initially and are reflected at some point back to the surface, the overall path being essentially vertical. In the case of refracted waves, the principal portion of the wave-path is along the interface between two layers and hence is approximately horizontal.

Seismic data recorded at near offsets is normally dominated by reflection waves, while at long offsets refraction waves dominate.

Some example refraction waves are so-called head waves and diving waves. A head wave typically travels in the relative shallow subsurface and will often be the first wave that is picked up by receivers at large offsets. These waves are often utilized by full-waveform-inversion (FWI) algorithms, which aim to build an accurate model of the subsurface including a high-fidelity velocity model.

Fiber-optic cables can also be used as seismic sensors. Distributed-sensing technology utilizing fiber-optic cables encompasses several techniques designed to replace individual, discrete measuring devices with what is essentially one long continuous sensor. Each of these techniques involves hooking up the end of a fiber-optic cable to a device known as an interrogator, which sends out a continuous train of laser signals (such as pulses or sweeps). The very faint reflections generated as each pulse or sweep is scattered at multiple points along the fiber-optic cable are then recorded. In this context, we are interested in a technique that is often referred to as Distributed Acoustic Sensing (DAS), and the interrogator is referred to as a DAS interrogator.

The method relies on the phase changes resulting from Rayleigh scattering of the laser pulses or sweeps from naturally occurring structural defects present throughout a standard optical fiber. The idea is that any acoustic or seismic wave will slightly stretch and compress the fiber as it passes through the ground within which the fiber is located.

Phase and magnitude are measured as a function of a delay of the reflected laser signal along the fiber. After phase demodulation, which can be electronically computed using an FGPA within the instrument, the output represents a true phase delay per gauge length and time sampling with a linear response. The results are averaged per fiber position and the spatial resolution is determined by the gauge length (GL). The output needs to be time integrated in order to provide a signal that is proportional to the fiber strain. A phase to strain conversion factor can be used, which will depend on the interrogation wavelength, refractive group index, and strain-optical coefficient of the fiber. In principle, anything that affects the strain on the fiber can be recorded. The phase of the light pulse at each scattering point corresponds to the variation in fiber length at that point on the cable. As such, each point acts like a tiny virtual microphone (hydrophone) or seismometer, whose distance along the fiber is established by measuring the time it takes the reflected light to complete its round trip. With pulse frequencies in, for example, the kilohertz range and the virtual sensors being spaced as little as a meter apart, the technique provides a potentially very fine-grained record of strain variation along the fiber with respect to both space and time. Through signal processing, the data collected can be used to produce a seismic trace with subsurface reflection and refraction energy roughly similar to that produced by more traditional sensors.

Traditionally, and predominantly, fiber-optic cables are used for telecommunication. Around 99 percent of all transoceanic data traffic goes through undersea cables which provide for internet usage, phone calls and text messages. The global internet is powered by vast submarine cables, and these cables therefore crisscross much of the globe. This is also the case in many of the marine oil and gas producing areas of the world, where telecommunication cables often extend both between offshore oil and gas infrastructures, and from these structures to the shore. Fiber-optic cables are also often located inside or along pipes and power cables.

DAS and purpose-built fiber-optic systems have in recent years been successfully deployed on several oil fields in connection with what is referred to as Permanent Reservoir Monitoring (PRM) systems and borehole seismic systems. It has been suggested that existing telecoms infrastructure could also be used with a DAS interrogator and traditional seismic sources to carry out a seismic survey of the earth's subsurface. Taweesintananon et al. 2021 describes a trial survey in Trondheimsfjord, Norway using existing telecommunications infrastructure fitted with an interrogator to perform a comparison with traditional near offset reflection survey methods. DAS methods were found to provide acceptable results. This study, however, used a traditional survey configuration and focussed on reflected data. Methods for obtaining better quality data which can be more easily processed, and which is less susceptible to noise, are therefore desirable.

According to a first aspect of the present invention, there is provided a method for performing a long-offset refraction seismic survey of a subsurface area of interest using a fiber-optic cable positioned at or near to the earth's surface and extending between a first cable end closer to the area of interest and a second cable end further from the area of interest, the method comprising: connecting an interrogator to an end of the fiber-optic cable, wherein the interrogator is configured to emit light into the cable through the end and detect reflected light from the cable; simultaneously activating one or more low frequency seismic sources at multiple positions along a source line and operating the interrogator to collect seismic refraction data, wherein the source line extends between a first source activation position closer to the subsurface area or volume of interest and a second source activation position further from the subsurface area or volume of interest, and wherein activating the source comprises activating the source in at least the first and the second activation positions; wherein the second source activation position is offset at least 9 km from the first cable end and the cable and source line extend in opposite directions away from the area of interest, and processing the collected refraction data to build up an image of or extract information about the subsurface area of interest. The subsurface area may be a 3D region, i.e. a volume of interest.

The interrogator may be coupled to any end of the cable, i.e. the interrogator may be coupled to the first end of the cable, or may be coupled to the second end of the cable. Generally, a physical end surface will be required to be present in order to send laser signals into the cable. The seismic data may be refracted seismic data or long-offset refracted seismic data, since the cable has good sensitivity towards such refracted acoustic waves.

The earth's surface on or near to which the cable is positioned may be a region of the seafloor. The cable may sit on the seafloor, or may be buried underneath the seafloor, or underneath a thin layer of silt on the seabed. The cable and source travel path each extend away from the area of interest such that the second source activation position and the second cable end are positioned further apart than the first cable end and the first source position, and are positioned on opposite sides of the subsurface area of interest. On opposite sides refers to the fact that the second cable end and the second source position are located within opposite quadrants of a circle centered on the area of interest and containing the second cable end and the second source position, when viewed from above.

The second cable end and the second source activation position may be at least 16 km, preferably at least 18 km, more preferably at least 20 km, at least 30 km, or at least 40 km apart in a horizontal direction (a horizontal offset of at least this size). The cable and source line may be in-line with one another, so that they extend along the same straight line, in which case the angular separation between the two in a horizontal plane will be around 180°. The cable thus extends from a first end that is either directly above or is near to the area of interest to a second end further from the area of interest, and the source travels from a point that is also near to the area of interest away from the area of interest in the opposite direction. “Near to” may refer to the fact that a horizontal offset between the first source position (or the first cable end) and the nearest position directly above the subsurface area of interest is less than 1 km. The cable and source travel path extend away from the area of interest in opposite directions so that the area of interest remains in between the source and at least the second end of the cable at all times during data collection and source activation. In a preferred example, the area of interest remains in between the source and any point on the cable at all times during data collection and source activation. The area of interest may have a horizontal diameter below around 20 km and may extend no more than 20 km, preferably no more than 10 km beneath the earth's surface in a vertical direction. The area of interest may, for example, represent all or part of a potential reservoir area (oil and gas), a storage area for CO₂ or other gas, or an offshore construction site (e.g. a windmill construction site).

This combination of source travel path and cable positioning relative to the position of the area of interest means that the majority of the seismic subsurface waves detected by the system will be refracted waves, rather than reflected. These refracted waves will predominantly also pass the receiver cable at a high angle of arrival which represents a shallow angle in relation to the direction in which the cable extends. This can contribute to a more detectible signal where DAS methods are used.

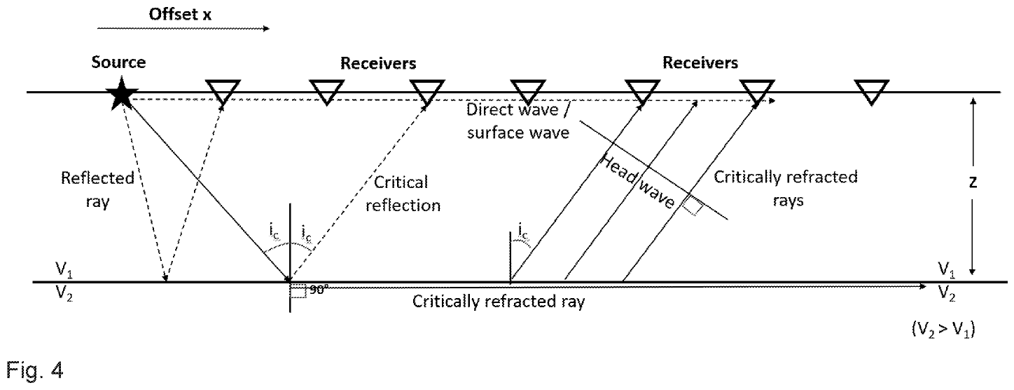

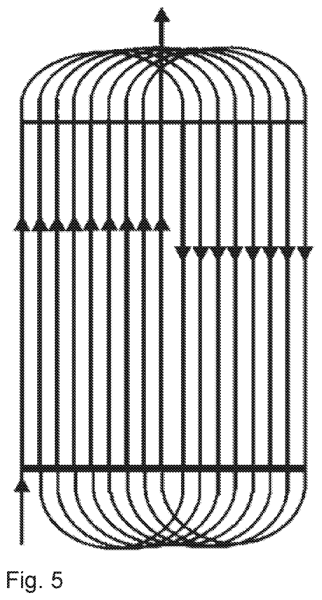

As an acoustic wave propagates downwards it will reach various boundaries or interfaces between geological layers. In the subsurface it is common that both density ρ and sound velocity v increase with depth. The result, governed by Snell's law, is that two different types of waves (reflections and refractions) are created, as illustrated in FIG. 4.

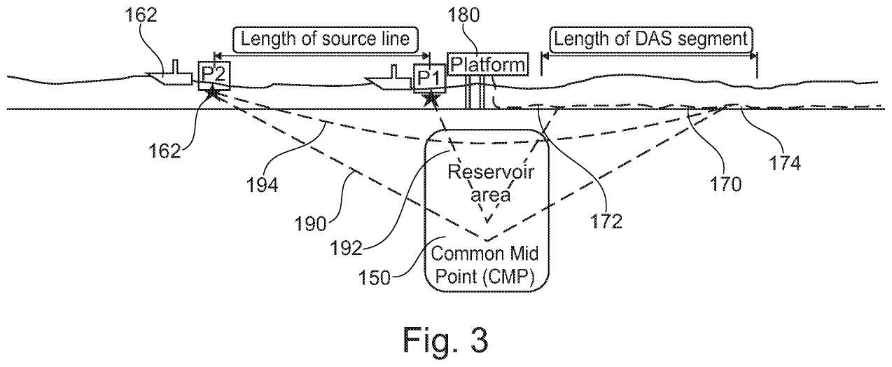

At long offsets, a direct wave will normally be strongly attenuated. The reflected waves are also often strongly attenuated, especially for the higher frequencies. What is normally recorded at the receivers is the refracted wave energy (head waves and especially diving waves) and refracted surface waves. The various refracted waves normally arrive at the receivers at around or above the critical angle. Depending on the geology, this can angle can typically be in the range of 30° to 60° from the vertical. For surface waves and diving waves, the arrival angle can be even higher (close to the horizontal) as illustrated in FIG. 3. Such a relatively high angle of arrival with respect to the vertical (i.e. an angle closer to the horizontal) turns out to be very beneficial for a DAS receiver, which has lower sensitivity to the near vertical arrivals (small angles). As for any low frequency reflected waves at long offsets, these will often arrive at a much lower angle, where a DAS sensor is less sensitive. They are therefore implicitly attenuated.

In summary, it has been discovered that the combination of low frequencies (which propagate long distance), refracted waves (which propagate in the not too deep subsurface where it is often desirable to investigate), and DAS receivers which are sensitive to waves arriving at a large angle with respect to the vertical combine to provide particularly beneficial results.

In processing, the detected refracted waves will typically be used in a full-waveform-inversion (FWI) algorithm, where information about the velocity variations in the subsurface is derived. This is valuable for direct and indirect imaging, and is typically very useful when, for example, looking for shallow gas accumulations that pose danger to both drilling and construction activities.

A low frequency source may refer to a source for which the energy distribution of the emitted acoustic radiation peaks in the range between 1 Hz and 40 Hz, preferably between 1 Hz and 30 Hz.

A horizontal offset, sometimes described herein as just an offset, refers to a horizontal distance (i.e. in a direction parallel to the plane of the earth's surface) between two positions, in this case the source and a point on the receiver cable. There may be an additional vertical offset, for example if the source is steered on the back of a marine vessel and the cable is situated on or buried just beneath the seafloor. The vertical offset will then be roughly equal to the depth of the water in the area where the cable is located. For a land-based survey, if the source is steered on the back of a vehicle, a vertical offset might be introduced by hills or valleys located in the source travel path, and may vary during the survey. The vertical offset can be accounted for during processing if necessary.

The activation of the source can be continuous or intermittent depending on the type of source used. An air-gun, for example, will be activated periodically. A marine or land vibrator will also be activated periodically (once per shot), but the output will be longer in duration in the form of a sweep which may vary in frequency with time. The vibrator output may be near continuous or even continuous. The source can be steered by way of a marine vessel or a land-based vehicle such as a truck.

The cable may be a section of a longer cable, so that the end to which the interrogator is not attached does not represent a physical end of the cable but rather an end to the section of the cable from which reflections are detected at the interrogator. The cable may alternatively represent an entire cable in which case both cable ends represent a physical end or cut-off. If the interrogator is coupled to the second end, the above will apply equally to the first end of the cable which may or may not represent a physical end surface.

In embodiments, activating the one or more low frequency seismic sources at multiple positions along the source line comprises directing a source along a travel path that extends between the first source activation position and the second source position whilst activating the source. The source may be activated periodically as it travels along the source line. The source will be activated at the first source activation position, at the second source activation position, and at multiple intermediate positions along the source line.

In embodiments, the method comprises steering the source such that it travels from the first source activation position to the second source activation position. The source can equally travel in the opposite direction starting at the second source activation position and moving to the first. The direction in which the source is steered may depend on each particular survey and may be adapted to maximize efficiency (depending on where the survey vessel travelling from to reach the survey area, for example). The source can also be driven from the first source position to the second position and then back, collecting data continuously, or can be driven in a racetrack pattern (as illustrated in FIG. 5), a circular pattern, or similar, between the two positions. This will provide some redundancy. The method may comprise steering the source so that it travels in a direct line between the first and second source positions (i.e. from the first to the second or from the second to the first in a straight line within a generally horizontal plane).

In embodiments, the cable extends in a substantially straight line from the first cable end to the second cable end, and the source line extends in-line with the cable in the opposite direction. Both the cable and source line in this case represent straight lines/paths when viewed from above. This is the most efficient way to carry out the survey. Waves are refracted and reflected within the area of interest at increasing or decreasing angles depending on the direction of travel of the source or the order of activations, and refracted waves are detected at the receiver cable to build up an image of the subsurface or derive subsurface information that can help build up an improved geological understanding. Generally, the source line will also represent a source travel path along which a source is directed/steered and simultaneously activated, such as on the back of a marine vessel.

In embodiments, the first cable end and the first source activation position are each located directly above the area of interest. The source may begin activating when it is above, or at least within 1 km horizontal distance of, the first cable end (or of the area of interest) at the first source activation position. After this, the source moves further and further from the cable so that the seismic energy is recorded at increasingly larger and larger offsets until it reaches the second source activation position (where it is also activated).

In embodiments, the one or more seismic sources is a low frequency source with an output peaking between 1 Hz and 40 Hz, preferably between 1 Hz and 30 Hz. The combination of the above survey configuration with a low frequency source is particularly beneficial because of how such sources are attenuated as compared to more conventional high frequency sources.

In embodiments, the fiber-optic cable comprises a section of a longer fiber-optic cable. In embodiments, the fiber-optic cable is coupled to or adjacent a power cable or another type of cable and can represent any cable carrying optical fibers. The fiber-optic cable may be close to or attached to the power cable or other cable, and may be associated with the power cable in the sense that the two have previously been installed together for a common purpose. In each case the cable is already present which significantly reduces operations costs. The fiber-optic cable may already be present within or next to a pre-installed/existing pipeline.

In embodiments, the source is an air-gun source (such as an air-gun array comprising one or more sub-arrays) and the method comprises varying the shot point interval (SPI) and/or source volume dependent on a horizontal offset between the source and the first cable end. In embodiments, the method comprises decreasing the SPI and/or increasing the source volume as the offset increases. For an air-gun array formed of many air-guns, the volume of the source array can be adjusted by switching on only a selected number of the air-guns to reduce the combined volume of the source, or vice-versa.

In embodiments, the method comprise controlling the SPI so that decreases proportionally with the increase in horizontal offset and/or controlling the source volume such that it increases proportionally with the increase in horizontal offset.

In embodiments, the source is a vibrator or a vibrator array, and the method comprises varying the sweep length dependent on the horizontal offset between the source and the first cable end. The source may be a marine vibrator or a marine vibrator array.

In embodiments, the method comprises increasing the sweep length as the offset increases. In embodiments, the method comprise controlling the sweep length such that it increases proportionally with the increase in horizontal offset.

In embodiments, the horizontal distance between the first source activation position and the second source activation position is substantially equal to the length of the cable from which reflections are detected. This keeps the source within a region where waves travelling via the area of interest can be detected at the cable, maximizing the efficiency of the survey.

In embodiments, the method comprises arranging the optic-fiber on the seafloor prior to connecting the interrogator to the fiber.

In embodiments, the fiber-optic cable comprises a section of a longer fiber-optic cable, the section representing the part of the cable from which reflected light can be detected at the interrogator.

In embodiments, the second source activation position is offset at least 15 km from the first cable end. The second source activation position may in some cases be offset at least 20 km, or at least 30 km, from the first cable end.

In embodiments, densely sampled seismic data can be stacked to form a group length. The fact that data can be densely sampled using DAS is therefore exploited by stacking to improve signal quality.

In embodiments, the method comprises selecting a spatial sampling interval and group-length of the fiber-optic cable based on the effective bandwidth of the subsurface reflection or refraction data of interest and the Nyquist sampling theorem. This is in order to maximize the SNR and avoid spatial aliasing in the recorded signal. The actual group-forming will ideally be done using software to allow for beam-steering. This accounts for the fact that the signals which arrive at the cable typically come in at an angle with a finite velocity.

In embodiments, processing comprises de-aliasing the data. The band-limited nature of the recorded seismic signal and its known apparent velocity variations can be exploited by accepting a degree of spatial aliasing in the signal, and the data can be reconstructed or de-aliased through processing at a later stage.

In embodiments, the data recorded and processed represents primarily refracted acoustic waves.

According to a second aspect of the present invention, there is provided a method for performing a seismic survey of a subsurface area of interest using a fiber-optic cable positioned at or near to the earth's surface and extending between a first cable end closer to the area of interest and a second cable end further from the area of interest, the method comprising: connecting an interrogator to an end of the fiber-optic cable, wherein the interrogator is configured to emit light into the cable through the end and detect reflected light from the cable; collecting data representing the phase and amplitude of the reflected light; and processing the collected data to build up an image of or extract information about the subsurface area of interest, wherein the method comprises collecting the data during activation of an external acoustic source. The survey may be a refraction seismic survey.

An external acoustic source refers to a source being operated as part of a separate, nearby, process unrelated to the present survey. The acoustic source may be being operated as part of a separate, nearby, seismic survey or may arise from a nearby construction process. The acoustic energy arising from the source can be the result of anthropogenic activity such as pile-driving, drilling noise, or engine noise, for example. The nearby survey may be a land-based or marine survey. The fiber-optic cable may represent or may be part of a telecommunications cable already present on or buried just below the earth's surface. The fiber-optic cable may be already present within or next to a pre-installed pipeline or power cable. Clearly, utilizing equipment for both the sensors and the source which are already present, and which do not need to be deployed only for the purpose of the present survey greatly reduces the cost and time required to set up and execute a survey. The only installation required is the connection of an interrogator to an end of the pre-installed fiber-optic cable, which can detect passing acoustic waves from the external source. The offset between the external source and the first end of the cable may be larger than 8 km, preferably larger than 9 km, 10 km, 15 km, or 20 km during at least a part of the survey, and this may be the case during the whole survey (during the whole time period during which the source is activated and data collected).

Embodiments of the present invention will now be described, by way of example only, with reference to the following diagrams wherein:

FIG. 1 illustrates a prior art configuration for a seismic survey;

FIG. 2 illustrates an example seismic source array including a plurality of air-gun sources;

FIG. 3 shows an example survey setup using long offsets;

FIG. 4 illustrates some different types of acoustic waves within a subsurface region; and

FIG. 5 shows one possible travel path for acoustic energy originating from a seismic source.

The method described herein generally improves on seismic surveying methods using fiber-optic cables, fitted with interrogators, as the seismic receiver or receiver array. The way in which the source is steered, the type of source used, and the relative positioning of the cable, the area of interest, and source are selected in order to maximise signal quality in a novel way and to fully exploit the capabilities of distributed acoustic sensing. In particular, a low frequency source is used, and the source path is chosen so that the offsets between the source and sensor cable are much larger than offsets typically used in seismic surveys. The method can make full use of pre-existing installations and equipment, such as external acoustic sources and pre-installed telecoms fibers. The method also takes advantage of refracted seismic waves which generally arrive at a shallow angle relative to the direction in which the fiber-optic cable extends. The fiber-optic cable is more sensitive to this type of wave than is to the conventionally used low angle (with respect to the vertical) reflection seismic waves.

A source-receiver offset refers to a horizontal distance (i.e. in a direction parallel to the plane of the earth's surface) from the source to the receiver. Near offset seismic methods therefore record waves that have travelled a short horizontal distance, but which may nevertheless have travelled a long distance in the vertical direction. Near offset data will normally arrive near vertically at the receivers. Where long offset data is concerned, the acoustic waves from the source have travelled a relatively long distance in a horizontal direction, but will not necessarily have travelled very far vertically. The term “long offset data” as used herein refers to data that has been acquired using a longer source-receiver offset in the horizontal direction than is traditionally used. Typically, this includes “large offsets”, which include horizontal offsets larger than around 8 km (which is a typical maximum offset for seismic streamer operation), and preferably to offsets larger than around 9 km, more preferably larger than 10 km, larger than 15 km, or larger than 20 km. Typical seismic streamers have lengths of up to around 8 km, and the sources are usually towed from the same vessel as the streamer, meaning that long offset data of the type described above cannot be collected using a traditional survey setup.

In some cases, rather than placing or installing the cable specifically for use in the survey, existing telecommunication fibers which are not in use, or which can be freed up from the normal job of sending telecom signals, can be used in order to replace a seismic sensor array. These types of cables are referred to herein as “dark fibers”. In theory, it might be possible to use a telecommunication fiber both as a seismic sensor array and to send telecoms signals at the same time. A telecommunication cable is typically made up of a bundle of optical fibers.

Where a receiver array or a fiber-optic cable representing a long receiver array is used, the offset for different “receivers” in the array will vary, and the offset will change throughout the survey as the source moves. It is, however, possible to define a range of offsets for each receiver, or for each point on the cable, which is to be covered during a survey. If a fiber-optic cable is used as a detector this will comprise a cable, which may represent a section of a longer cable, usable to detect passing acoustic waves. In the process of acquiring long offset data, some sensors in a sensor array (corresponding to different positions on the cable) may also record shorter, more conventional, offset data. At least a portion of the data will, however, be collected at offsets larger than 8 km, preferably larger than 9 km, larger than 10 km, larger than 15 km, or larger than 20 km.

A low frequency seismic source refers to a source that is designed to produce low frequency data, or at least to emit acoustic radiation with significantly more energy at low frequencies and less energy at high frequencies than a conventional seismic source. A low frequency source may therefore also produce energy at higher frequencies, and the sensors associated with the survey may record data at higher frequencies. Low frequency seismic data is typically produced by large air-gun arrays (more than 3000 cu.in volume), by air-guns with large chambers (typically more than 1000 cu.in in volume), or by vibrators, such as marine vibrators, however other source types may also be used for this purpose. A low frequency source is generally also towed relatively deep, typically deeper than ˜8 meters. Some examples of air-gun-based low frequency sources suitable for use with the system/methods of the present invention are the “Harmony” source offered Shearwater, the “Gemini” source offered by ION, and the “Tuned pulse Source (TPS)” source offered by Sercel. Low frequency data refers to seismic data in the range between around 1 Hz to around 50 Hz. This is somewhat lower than conventional seismic data, where most of the energy is in the 3 Hz-250 Hz range. A low frequency source may refer to a source for which the energy distribution of the emitted acoustic radiation peaks in the range between 1 Hz and 40 Hz, more preferably between 1 Hz and 30 Hz, and most preferably between 1 Hz and 20 Hz.

The dedicated low frequency source can be activated with a relatively long Shot-Point Interval or Sweep-Point Interval (SPI) compared to conventional seismic sources. The SPI refers to the time elapsed between two actuations of a source. In conventional seismic acquisition a commonly used SPI is 25 meters, roughly corresponding to 10 seconds (when the vessel towing the source has a ground speed of around 5 kn). In the present system, longer SPIs of more than 10 seconds can be used. The SPI will preferably be above 10 seconds and less than or equal to 100 seconds, preferably between 20 seconds and 100 seconds, or between 20 second and 40 seconds. There are several reasons for this. Firstly, due to the relaxed sampling requirements at low frequencies, there is no need to sample (activate the source) very densely. Secondly, a low frequency source will normally have a large volume of air. It can take time to fill this air-reservoir with the available compressor capacity through the air-hoses. As such, an LF source is physically limited in terms of SPI. In the case of a low frequency marine vibrator it normally takes time to emit “enough” energy, which will limit the SPI.

Where a long offset is used to collect marine seismic data, the received signal will include normal modes, which correspond to acoustic energy propagating within the water column and reflecting back and forth between the sea surface and the water-bottom with very little attenuation. This type of acoustic energy often contains acoustic energy from the full frequency band (up to above 100 Hz) and is often referred to as seismic interference noise. This noise can sometimes be detected up to around 100 km away from its source, and carries little useful information about the subsurface. Additional noise arises from other sources, including from the recording system itself, from human activity, known as anthropogenic noise (engines, gearboxes, other seismic surveys, and so on) and from sounds naturally occurring in the ocean (swell noise, earthquakes, etc). Traditional signal processing techniques can be used in order to attenuate this type of noise in the signal (Helebnikov et al. 2021).

Some of the acoustic energy from the source will propagate into the subsurface before it is eventually reflected or refracted up to seismic receivers. At long offsets, such as the offsets used here, the most interesting signals will generally arise from refracted waves and/or diving waves and head waves. Some of these signals, especially the head waves, carry information which is useful in imaging and characterising the subsurface, typically utilizing FWI algorithms. Using modern signal processing techniques, information can be extracted from the various refracted waves in the signal. Refracted seismic waves are waves that have been refracted at or beyond the critical angle, and these waves are commonly known as head waves or refractions (Sheriff and Geldart, 1995). The travel path for the refracted waves from source to receiver at long offsets will be predominantly horizontal relative to the earth's surface, rather than predominantly vertical. In addition to head waves, refraction seismic methods also detect diving waves, which change their direction of travel, or bend, as the velocity of the wave increases so that their travel path becomes closer and closer to a horizontal direction of travel. At a given depth they turn and follow a similar bent path back to the surface again.

The present invention can employ one or more dark fibers fitted with a DAS interrogator, or one or more custom-made optical-fiber based seismic sensors, in a seismic survey of a region of the subsurface of the earth. The invention is usable on land, but is particularly suited to use in marine seismic surveys. Use of very long (horizontal) offsets between the seismic source and the receiving cable during the survey allows the sensor to receive signals propagating at an angle where it has good sensitivity. The quality of the data collected can therefore be significantly improved as compared to previous methods where only near offset data (coming in at a less advantageous angle with respect to sensor sensitivity) has been recorded.

The reason for this is that optical fibers are more sensitive to acoustic waves travelling past the horizontally oriented cable at an angle which is itself closer to a horizontal travel path. Where the source is located directly above the seismic array, as in a typical marine survey, acoustic waves will tend to pass the receiver, which in this case comprises a fiber-optic cable, travelling in a generally vertical direction after having been reflected from the subsurface directly beneath the cable. Use of a large offset will result in detection predominantly of refracted waves, head waves and diving waves, which pass the fiber-optic cable travelling at a shallow or small angle to the horizontal, thus maximising the sensitivity of the seismic detector for the acoustic waves making up the data-rich part of the seismic signal.

The quality of the data can be further improved by employing low frequency sources to collect data from a subsurface area or volume of interest. This is because high frequency (HF) signals are attenuated much more rapidly than low frequency (LF) signals, and at long offsets LF signals will provide better data. The area of interest comprises any region of the subsurface which it is desired to image or collect data from. This might be a known reservoir (i.e., an oil and gas or CO₂ storage site), an area where it is desired to search for seabed minerals, or an area where it is desired to investigate the subsurface before starting potential construction work (windmills, pipelines, etc). An LF source, or a source having a reduced high frequency output when compared to typical seismic sources, is also beneficial from an environmental point of view. The method described herein will therefore be particularly suitable for use in environmentally sensitive areas.

An example configuration for a survey is shown in FIG. 3. The area of interest 150 in this case is an underground reservoir or potential reservoir. In order to detect signals passing through or being reflected or refracted from the area of interest seismic source(s) 160 (which may be any source of acoustic waves including air-gun arrays and/or vibrators) such that the midpoint position between the source and one or more receivers in the sensor array is within this area of interest. By manoeuvring the source(s) it is possible to collect data from the area of interest over time and using different source positions, which can be processed to extract information about subsurface properties. FIG. 3 also shows reflected waves (190 and 192) and a refracted diving wave (194).

A fiber-optic cable 170 is positioned on the seafloor, extending between a first end 172 at a position above the reservoir area and another physical end at another location, such as a shore station several kilometres away (not shown). This may be a cable that is already present on or within the seabed because it is being or has previously been used to transfer telecom data. Utilizing equipment which is pre-installed has the potential to provide a very cost-effective method for collecting seismic data. This may be of particular importance where the data is being used to examine a region of the subsurface with a view to building a windmill or investigating a CO₂ storage reservoir, which are especially cost sensitive operations. Waves travel from the source 160 towed behind a seismic vessel 162 which travels during the survey in a path which covers an area of the seafloor located on an opposite side of the area of interest to the fiber-optic cable being used as a sensor array. At long offsets the predominantly refracted acoustic waves travelling from the source to the cable therefore pass the cable travelling at a shallow angle to the direction in which the cable extends, or on a path that is close to the horizontal. At long offsets it will be predominantly various refracted waves that arrive close to or beyond the critical reflection angle which will be detected. This critical reflection angle is typically between 30° and 60° from the vertical, depending on the local geology.

The fiber-optic cable is connected at or beyond the first end 172 to an interrogator, such as a DAS interrogator. In the example shown the interrogator is installed on a platform 180 located above the reservoir, and the interrogator is able to turn the first 50 km to 100 km of the optical fiber (the length of the DAS segment) into an acoustic sensor array by sending laser signals (pulses or sweeps) into the cable. The platform can be dispensed with in some examples, and the interrogator can be located at or near the end of the cable on the seabed or on a vessel or floating platform. The first end 172 represents one end of the section of cable being used to detect acoustic waves and the second end 174 represents the other end of this section. This section represents the fiber-optic cable of the first aspect described above, and is the section acting as a seismic receiver.

The source 160 towed by the vessel 162 may comprise a low frequency seismic source. The source can be in the form of one or more air gun array(s) or marine vibrator(s). Other source types like explosives, water guns, and sparkers may also be possible choices. In order to image the subsurface in the area of interest 150 which in this case is the reservoir area (the volume directly underneath the platform 180 in FIG. 3), the source(s) are deployed such that the subsurface common reflection point(s) (CMP) are inside this area, or so that diving waves and refracted waves pass through this area en-route from the source to the cable. During the survey, the vessel is steered so that the source travels in an inline direction, starting closest to the first end 172 of the fiber-optic cable and travelling away from the cable in an opposite direction to that in which the cable extends from its first end 172 to its second end 174. The offset as the survey proceeds therefore increases for any point on the cable, and the subsurface (which could be a reservoir) is imaged for a series of offsets gradually increasing in size.

FIG. 3 illustrates the length of the fiber-optic cable 170 which can function as a seismic sensor, or seismic sensor array. This does not represent the entire cable in most cases, but a section of the cable closest to the interrogator and located on or near the seafloor or the earth's surface for a land-based survey. This section may be between 10 km and 300 km, preferably between 10 km and 100 km or between 10 km and 50 km, and most preferably between 20 km and 40 km long. It may be that the interrogator itself is capable of measuring reflection data from a longer section of the cable, but seismic data is only collected (because it is only really useful) for the first 10 km to 50 km of the cable. If this is the case, the “cable” as defined herein refers to the section of the longer fiber (usually a section between 10 km and 50 km long) being employed as a seismic sensor, and from which seismic data is collected and processed. If the fiber section measured by the DAS interrogator is X₁ km long, extending from first end 172 to second end 174 in a straight line away from the region of the seabed under which the reservoir is located, then the survey vessel and sources may be directed to follow a path that is also X₁ km long, beginning from a first source activation position P1 that is also directly over the reservoir or directly above the first end of the cable section and extending in a straight line away from the reservoir in an opposite direction to the direction in which the cable extends to a second source activation position P2. This will allow CMP data from within the area of interest to be recorded and will fully exploit the sensor array.

In some cases, the travel path of the source vessel may begin further towards the second end of the cable, so that the source vessel first travels directly over a section of the cable and then continues past the first end of the cable, over the region of interest, and onwards. The vessel may also or alternatively continue further than X₁ km beyond the first end of the cable. The extra source points generated will then no longer have any CMPs in the reservoir area of interest, since reflected/refracted waves from the area of interest will meet the cable outside of a detectible range. However, these may still provide valuable information from other nearby surface features, and thus contribute to a more general understanding of the subsurface structures.

Obviously, rather than starting from a position near to or directly above the first end of the cable, the source vessel can travel in an opposite direction. In the example shown in the figure this means that it can either start at the first source activation position P1 and end up at the second source activation position P2 or it can start at P2 and end up at P1.

A plurality of cables can also be positioned extending away from the platform in different directions, in which case the vessel may be directed to follow a number of different source lines configured for maximum response of each of the cables in turn. These cables may be positioned specifically for use in the survey, or may form part of a pre-existing network of telecommunications cables.

If a cable is made up of multiple line segments, meaning that the cable includes one or more turns, the source positions during the survey can be selected to account for this in order to ensure that that CMP positions within the area of interest are covered. A cable made up of multiple line segments is a cable with one or more turns along the cable length. The cable may, for example, may extend 10 km in a northwards direction before turning 10 degrees westward and continuing for another 40 km. In this case the cable will include two segments, a first which is 10 km long and a second which is 40 km long. Obviously, the number of turns and the length of the segments can be adapted depending on how the cable has been installed previously, or on the geology of the area on or in which the cable is laid. The source line may reflect the turns in the cable itself, i.e. in the case described above may also include a 10 degree turn in the course after 10 km. It is also possible to acquire more than one source line for each fiber segment. By acquiring multiple source lines, it is possible to obtain CMP data from multiple locations inside the area of interest, and as such get volumetric (3D) information about the subsurface rather than just a 2D depth-slice, as will be provided by a single source-line.

In the example shown in FIG. 3 the source line or source travel path is in-line with the fiber segment. This means that the direction of travel of the source and vessel is in line with the direction in which the fiber extends (these both extend along the same straight line). The vessel can alternatively sail in a racetrack pattern as shown in FIG. 5, in circles, or in ovals at an appropriate distance away from the fiber segment to ensure that the CMP positions generally fall within the (reservoir) area of interest. In this way, too, it may be possible to acquire 3D dataset of the subsurface. Generally, though, the position of the source vessel during the survey will at all times be above a region of the seafloor located on the opposite side of the area of interest to the cable section being used to form the sensor.

The long offsets achieved by steering the source in the manner described above provides especially good results when combined with a fiber-optic cable converted to function as a seismic sensor. This is because the response to P-waves on a DAS fiber depends on squared-cosine of incidence angle. For waves travelling at 90° (i.e. waves travelling vertically when passing the sensor located on the seafloor as in conventional reflection seismic surveys), only very small response (approaching zero) is recorded. The S-wave response depends on sin(2θ), where θ is the incident angle of the incoming wave. There is no response for waves having an incident angle of 180° (i.e. travelling parallel to or along the length of the fiber itself), and the response is also approaching zero for a wave travelling at 90° (coming up vertically from the subsurface), as the fiber cannot in either case be detectibly stretched or compressed.

Processing may comprise separation of the various wave-types (i.e. reflected waves if used and refracted waves such as head waves and diving waves). Head waves, which often travel generally horizontally in the subsurface, will often arrive earlier than many the other wave types, and are therefore in principle fairly straightforward to pick out and separate from the other signals in the data. More elaborate algorithms for wave separation are also available, and will be known to the skilled person. See for example Kazei et al., (2013). Since the refracted data will be richer in this case, only, or substantially only, the refracted data may be used to extract information about the subsurface.

As mentioned, existing telecommunication cables can be employed as part of the sensor or sensor array of the invention. To form the array, the existing cable is simply fitted with a DAS interrogator configured to send a laser signal (for example pulses or sweeps) through the cable and detect a reflected laser signal. The DAS interrogator, and/or a separate detector for receiving the reflected signal, can be coupled to a processor, which may be collocated with the interrogator or may be remotely located. Existing telecommunication cables have a fixed position, and this position is not necessarily ideally located with respect to the area of interest. However, telecommunication cables are normally very long, extending tens and even hundreds of km, meaning that one such cable, or a conveniently positioned section of a cable, can be utilized to record long offset data which would otherwise be complicated and expensive to acquire. Telecommunication cables generally lie on or just below the seafloor or the ground, rather than being buried within the subsurface. This could potentially lead to reduced coupling resulting in higher levels of noise, however in many areas including in the North Sea, where there are a lot of fibers available within telecom cables, the sea floor is generally flat, and is covered with a fine sediment. There are few boulders or big rocks which could cause coupling problems. This means that a “standard” telecommunication cable will lie partially buried within the top sediment layer and will often for this reason have a decent coupling to the ground.

At offsets beyond 10-15 km, the highest frequency of interest will typically be around 25 Hz or lower. This will then be the highest frequency processed as part of the seismic data used to extract information about the subsurface structure and makeup. The relationship between frequency f and wavelength λ of acoustic radiation is governed by the well-known formula: λ=C₀/f, where C₀ denotes the speed of sound (typically ˜1500 m/s in water). A 20 Hz acoustic wave therefore has a wavelength of around 75 meters. If only long wavelength radiation is of interest, such as wavelengths in a range around 75 meters, there is no need for a fine spatial sampling of the fiber using the interrogator. Instead, it is possible to average or stack up measurements taken over relatively large intervals.

In order to optimize the Signal-to-Noise Ratio (SNR), the ability of the DAS sensor to provide dense sampling can be utilized, and then these samples can be “stacked” during processing to form a group-length. This has the potential to make the measurements more robust, due to the fact that any potential noise, for example noise arising from a non-optimal local coupling to the ground, is averaged or processed out. Further, dense sampling and stacking using the DAS sensor reduces the amount of data which is required to be handled and stored, and this may represent significant savings in terms of processing power and disk space.

Strain on the cable is not measured at individual points but is instead measured across a section of the fiber, analogous to a moving average filter, wherein the length of fiber being sensed can be referred to as the gauge length. The gauge length is therefore also a key acquisition or processing parameter.

Optimizing the SNR of the measured signal at the frequencies of interest can be achieved by adjustment of the gauge length, adjustment of the spatial sampling size, and by using stacking methods during processing of the data, as mentioned above. Such stacking methods may, when implemented in software, be made to account for the arrival angle and the apparent velocity of the recorded signal.

The Nyquist sampling theorem states that a bandlimited continuous-time signal can be perfectly reconstructed from its samples if the waveform is sampled over twice as fast as its highest frequency component. Combining this with the equation linking wavelength and frequency of a sound wave gives: Ideal_Sampling_Interval<=C₀/(2*Highest_Frequency_Of_Interest). For a particular frequency range, this formula then gives the maximum (and ideal) sampling interval for a DAS fiber.

If the “highest frequency of interest” is 20 Hz, then a sufficient sampling interval or group-length is 37.5 meters. Taking further advantage of the fact that the signal to be detected is a bandlimited signal, and the fact that the apparent velocity of the reflected waves is bounded by the speed of sound in water (˜1500 m/s) and the speed of sound in the deep subsurface (˜4000 m/s), further relaxation of the sampling density can be introduced. The required minimum spatial sampling for a 20 Hz wave at an apparent speed of 4000 m/s incident on the cable is therefore around 100 m, with the apparent wavelength at 200 m. This shows that the maximum wavenumber bandwidth to be reconstructed is between 1.0/75 and 1.0/200 at 20 Hz or δk=(1.0/75−1.0/200)=0.00833 (1/m unit). This is called the effective maximum wavenumber bandwidth to be reconstructed at 20 Hz requiring a minimum of 1.0/(2*δk)=60 m spatial sampling in addition to the prior knowledge we already have of δk (between 1.0/75 to 1.0/200). Using this knowledge, the signal can then be reconstructed/de-aliased at each frequency in its corresponding wavenumber band where the signal is constrained. This allows an otherwise under-sampled signal to be reconstructed or de-aliased, but requires that there is negligible signal or noise at that frequency outside this limited wavenumber band. Based the recorded or expected highest frequency of interest at any given offset, the formulas given above can be used to determine a minimum required sampling interval. Based on an initial dense spatial sampling interval from the DAS interrogator, we can then use the formula to find a group-length over which we stack up the data to maximize the SNR. The group-length may be between 20 m and 50 m, preferably between 30 m and 40 m.

For lower frequencies than 20 Hz the number of samples required per unit length is lower than the number required at 20 Hz (less dense sampling is possible). At 10 Hz the wavelengths are between 150 m and 400 m, resulting in a wavenumber bandwidth of δk=1.0/150−1.0/400. The minimum spatial sampling to avoid aliasing for 10 Hz is then 1.0/(2*δk), or around 120 m. As mentioned earlier, in order to maximize the SNR we might want to sample at a much denser spacing than this, and then, through processing, group-form the data to this maximum theoretical possible spatial sampling interval.

For any of the survey configurations and methods described herein, where one or more air-guns are used as the seismic source, the air-gun SPI and/or the total volume of the source can be adjusted based on the offset. That is, when the vessel is relatively close to the first end of the fiber segment or cable, the source can be fired in flip-flop mode in order to achieve a high fold. When the source is in a position that is further away, where the SNR will generally be lower, both the flip and the flop source can be fired simultaneously to achieve a stronger signal. In the latter case, the SPI may also need to be reduced to allow for a limited compressor capacity. For a typical air-gun array including 2 to 5, preferably 2 to 3 sub-arrays of multiple air-guns, multiple such arrays, each comprising between 10 and 70, preferably around 30 air-guns, can be fired together as one array of larger combined volume. Alternatively, a selected number of air-guns within one or more of the arrays can be switched off to achieve the desired total volume for each shot. The volume of the source can be made to increase incrementally. The volume of the source can be increased roughly proportionally to the offset distance. The SPI can be decreased incrementally or roughly proportionally to the offset distance.

Where one or more marine vibrators are used as the seismic source, the sweep length can be adjusted depending on the offset. For example, for near offsets a first sweep-length can be selected in order to achieve a predetermined SNR. As the source moves away from the fiber, or for longer offsets, the sweep-length can be increased to ensure that the signal at the receiver side is sufficiently large. This can be referred to as an offset dependent sweep length. The sweep length can vary as the source moves away from (or towards) the first end of the cable so that the sweep length is proportional to the horizontal offset distance. Alternatively, ranges of offset can be associated with a particular sweep length, so that as the source moves away from the cable the sweep length increases incrementally or in a step-wise manner.

In an embodiment, external sources from another nearby survey can be used as the acoustic sources. Refracted acoustic energy from a survey designed to primarily image reflected acoustic radiation from an area of the subsurface directly below the source or source array can also be used to extract subsurface information from an area of the subsurface in between the external source and a fiber-optic cable located on the seafloor using refracted acoustic energy. The nearby survey could be operating around 25 km away, for example, so that the offset is around 25 km. The recorded data could then be processed to provide information about the subsurface volume located between the source points and the DAS receivers.

If the source was much further away, for example more than 50 km from the first end of the DAS cable, only the normal modes traveling in the water column will likely be visible. This is often referred to as seismic interference noise, and it does not carry any information about the subsurface. Preferably, then, the sources will be located at no more than a 50 km offset.

The general methodology is described above in a marine setting. The same principles may of course be applied in a land-based seismic survey. The platform in FIG. 3 could therefore be replaced with an onshore oilrig, for example, and the vessel with a vibroseis truck or inline explosive sources, controlling the source positions such that CMPs are recorded from a subsurface area of interest. The fiber-optic cable used could still be within/attached to/close to an existing telecommunication or power cable.

1. A method for performing a long-offset refraction seismic survey of a subsurface area of interest using a fiber-optic cable positioned at or near to the earth's surface and extending between a first cable end closer to the area of interest and a second cable end further from the area of interest, the method comprising:
connecting an interrogator to an end of the fiber-optic cable, wherein the interrogator is configured to emit light into the cable through the end and detect reflected light from the cable;
simultaneously activating one or more low frequency seismic sources at multiple positions along a source line and operating the interrogator to collect seismic refraction data, wherein
the source line extends between a first source activation position closer to the area of interest and a second source activation position further from the area of interest, and wherein activating the source comprises activating the source in at least the first and the second activation positions; wherein
the second source activation position is offset at least 9 km from the first cable end, and
the cable and source line extend in opposite directions away from the area of interest, and
processing the collected refraction data to build up an image of or extract information about the subsurface area of interest.

2. A method according to claim 1, wherein activating the one or more low frequency seismic sources at multiple positions along the source line comprises directing a source along a travel path that extends between the first source activation position and the second source activation position whilst activating the source.

3. A method according to claim 2, comprising steering the source such that it travels from the first source activation position to the second source activation position.

4. A method according to claim 1, wherein the cable extends in a substantially straight line from the first cable end to the second cable end, and wherein the source line extends in-line with the cable in the opposite direction.

5. A method according to claim 4, wherein the first cable end and the first source activation position are each located directly above the area of interest.

6. A method according to claim 1, wherein the one or more seismic sources is a low frequency source with an output peaking between 1 Hz and 40 Hz.

7. A method according to claim 1, wherein the fiber-optic cable is coupled to or close to a power cable or is part of a telecommunications cable.

8. A method according to claim 1, wherein the source is an air-gun source and the method comprises varying the SPI and/or source volume dependent on horizontal offset between the source and the first cable end.

9. A method according to claim 8, wherein the method comprises decreasing the SPI and/or increasing the source volume as the offset increases.

10. A method according to claim 1, wherein the source is a vibrator or vibrator array, and the method comprises varying the sweep length dependent on the horizontal offset between the source and the first cable end.

11. A method according to claim 10, wherein the method comprises increasing the sweep length as the offset increases.

12. A method according to claim 11, wherein the method comprise controlling the sweep length such that it increases proportionally to the increase in horizontal offset.

13. A method according to claim 1, wherein the horizontal distance between the first source activation position and the second source activation position is substantially equal to the length of the cable from which reflections are detected.

14. A method according to claim 1, comprising arranging the fiber-optic cable on the seafloor prior to connecting the interrogator thereto.

15. A method according to claim 1, wherein the fiber-optic cable comprises a section of a longer fiber-optic cable.

16. A method according to claim 1, wherein the second source activation position is offset at least 15 km from the first cable end.

17. A method according to claim 1, wherein the fiber-optic cable comprises all or part of a telecommunications cable or is coupled to or adjacent a power cable.

18. A method according to claim 1, wherein the method comprises selecting a sampling interval and group-length of the fiber-optic cable based on the effective bandwidth of the subsurface reflection or refraction data of interest and the Nyquist sampling theorem.

19. A method according to claim 1, wherein processing comprises de-aliasing the data.

20. A method according to claim 1, wherein the data recorded and processed represents primarily refracted acoustic waves.
